(19) United States
(12) Patent Application Publication
(10) Pub. No.: US 2010/0018114 A1
(43) Pub. Date: Jan. 28, 2010

(54) SUPPORT FOR FLOWER STALK

(76) Inventor: Cheng-Kuang Yang, Miaoli City (TW)

Correspondence Address: Chien-Hui Su, P. O. Box 70-121 Taichung, Taichung City, 40899, TW

(21) Appl. No.: 12/178,658

(22) Filed: Jul. 24, 2008

(51) Int. Cl. A01G 9/12

(52) U.S. Cl. 47/47

(57) ABSTRACT

A support for flower stalks includes a base and two tubes connected to the base. The base has two concavities defined in a bottom thereof and two protrusions upwardly extending from a top thereof. The concavities are adapted to be connected to a pot for assembling steadily. One end of each tube is mounted with a corresponding one of the protrusions. Each tube has a partial opening laterally defined therein for inserting the flower stalk into the tube. Each tune is divided into an upper portion and a lower portion by the partial opening. The upper portion is longer than the lower portion for supporting the flower stalk to prevent the flower from being bended or broken and the lower portion is mounted with the corresponding one of protrusions for securing the tube.

### BACKGROUND OF THE INVENTION

1. Field of the Invention

The present invention relates to gardening tools, and more particularly to a support for flower stalks.

2. Description of Related Art

Orchids, one of the most attractive flowers, are grown by gardeners and bred by hobbyists around the world. Phalaenopsis are among the most popular orchids due to their elegant figure and pleasant fragrance. To keep their elegant figure and avoid flower stalk bending or breaking, a support for flower stalks is needed.

A conventional support for flower stalks in accordance with the prior art shown in FIG. 9 comprises a supporting rod 51. One end of the supporting rod 51 is inserted into a medium in a pot 50 vertically. Multiple fasteners 52, i.e. clips or wires, are used to fix flower stalk with the supporting rod 51. By adjacency of the supporting rod 51, the flower stalk grows uprightly. However, the medium is formed by fir bark and sphagnum moss such that the medium is loose. Besides, the ideal condition for cultivating is high humidity. This also results the loose medium. Therefore, the inserted supporting rod 51 is unstable so that the supporting rod 51 inclines or collapses for failure to support the flower stalk.

Furthermore, the multiple fasteners 52 are needed to change the positions or add the number after the flower stalk grows. It is time consuming and complicated process for mass cultivation. Besides, the probability of damaging the flower is also raised when changing the positions of the multiple fasteners 52 or adding more fasteners 52.

The present invention has arisen to mitigate and/or obviate the disadvantages of the conventional support for flower stalks.

### SUMMARY OF THE INVENTION

The main objective of the present invention is to provide an improved support for flower stalks, in that a stable, easy to operate and time-saving support is obtained.

To achieve the objective, the support for flower stalks includes a base and at least one tube connected to the base. The base has at least one concavity defined in a bottom thereof and at least one protrusion upwardly extending from a top thereof. The at least one concavity is adapted to be connected to a pot for assembling steadily. The at least one tube has a partial opening laterally defined therein for inserting the flower stalk into the at least one tube. The at least one tube is divided into an upper portion and a lower portion by the partial opening. The upper portion is longer than the lower portion for supporting the flower stalk to prevent the flower stalk from being bended/broken and the lower portion is axially disposed to the at least one protrusion for securing the at least one tube. The base has at least one hook downwardly extending from a distal end thereof and adjacent to the at least one concavity for enhancing steadiness.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a support for flower stalks in accordance with the present invention;

FIG. 2 is a perspective view of the support for flower stalks in accordance with the present invention;

FIG. 3 is a cross sectional view taken along line 3-3 of FIG. 2;

FIG. 4 is an operational schematic view of the support with flower stalks;

FIG. 5 is a partial cross sectional view of FIG. 4;

FIG. 6A is an exploded perspective view of a second embodiment of a support for flower stalks in accordance with the present invention;

FIG. 6B is a partial enlarged view of FIG. 6A showing the assembly of a base and a pot;

FIG. 7 is an exploded perspective view of a third embodiment of a support for flower stalks in accordance with the present invention;

FIG. 8 is a cross sectional view of FIG. 7; and

FIG. 9 is a perspective view of a conventional support for flower stalks in accordance with the prior art.

### DETAILED DESCRIPTION OF THE INVENTION

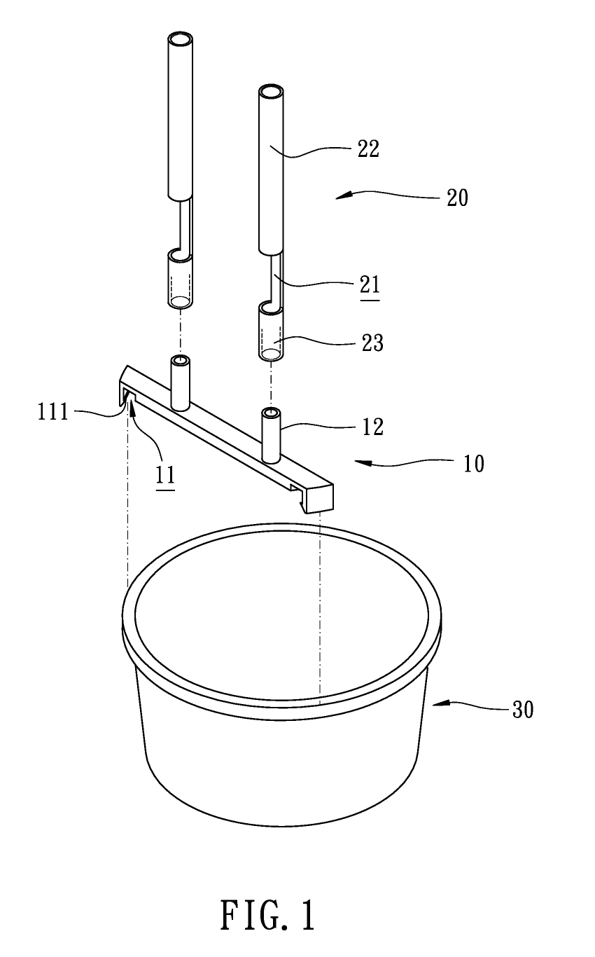

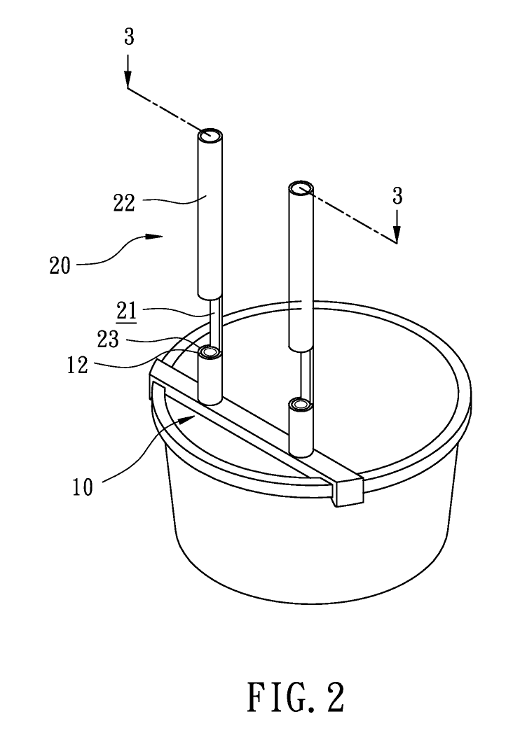

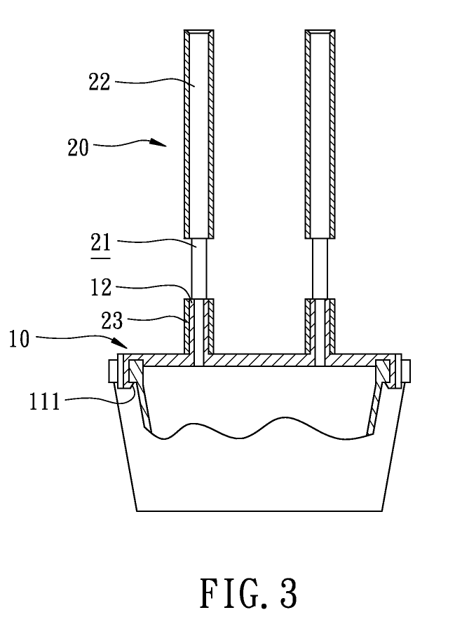

Referring to the drawings and initially to FIGS. 1-5, a support for flower stalks in accordance with the present invention comprises a base 10 and at least one tube 20 longitudinally connected to the base 10.

The base 10 has at least one concavity 11 defined in a bottom thereof and at least one protrusion 12 upwardly extending from a top thereof. In the best embodiment, the base 10 has two concavities 11 and two protrusions 12. In the following, the best embodiment is described. The concavities 11 are adapted to be connected to a top edge of a pot 30 for assembling steadily. The base 10 has at least one hook 111 downwardly extending from a distal end thereof and adjacent to one of the concavities 11. The at least one hook 111 engages with the top edge of the pot 30 for enhancing steadiness.

Two tubes 20 are axially disposed to the two protrusions 12. Each tube 20 has a partial opening 21 laterally defined therein for inserting the flower stalk into the tube 20.Each tube 20 is divided into an upper portion 22 and a lower portion 23 by the partial opening 21. The upper portion 22 is longer than the lower portion 23 for supporting the flower stalk and the lower portion 23 is axially disposed to a corresponding one of the protrusions 12 for securing the tube 20.

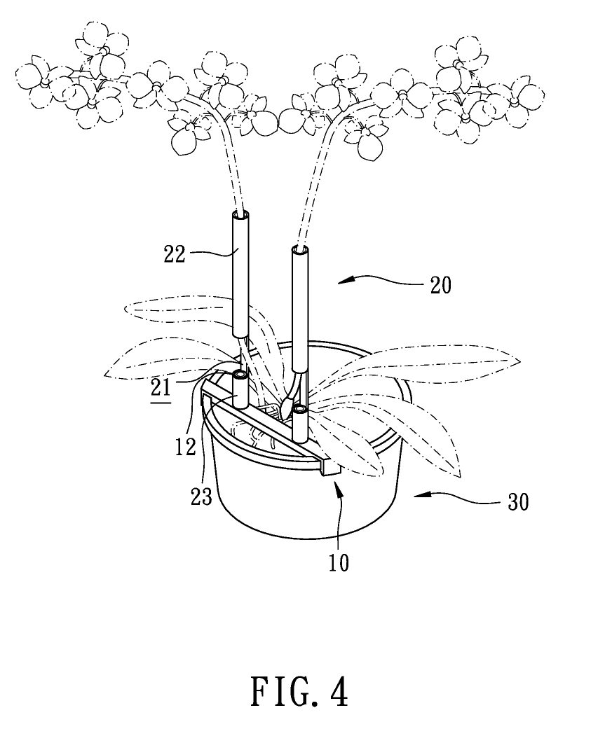

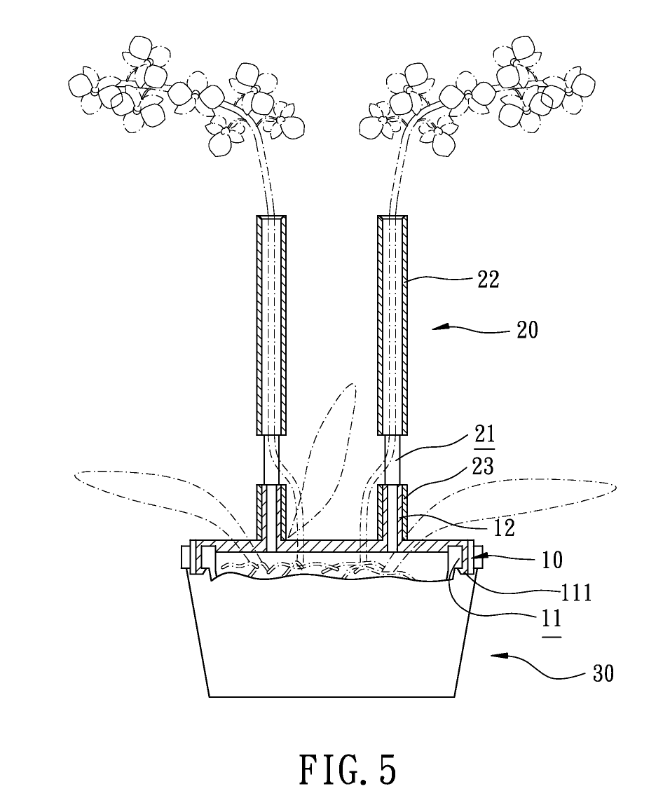

FIGS. 4 and 5 show the operational schematic views of the support in accordance with the present invention. The orchid is cultivated in the pot 30. The young shoot of orchid is inserted into the upper portion 22 of the tube 20 via the partial opening 21 and grows up inside the upper portion 22. The orchid stalk is supported by the tube 20 to prevent from being bended or broken. Furthermore, the tube 20 is firmly connected to the base 10 and the base 10 is securely engaged with the pot 30. The tube 20 doesn't collapse or incline. During the growth of the orchid, there is no need to adjust the position of tube 20 or add any other elements for supporting the stalk. The cultivating process is simplified, therefore the time and cost for mass cultivation is reduced.

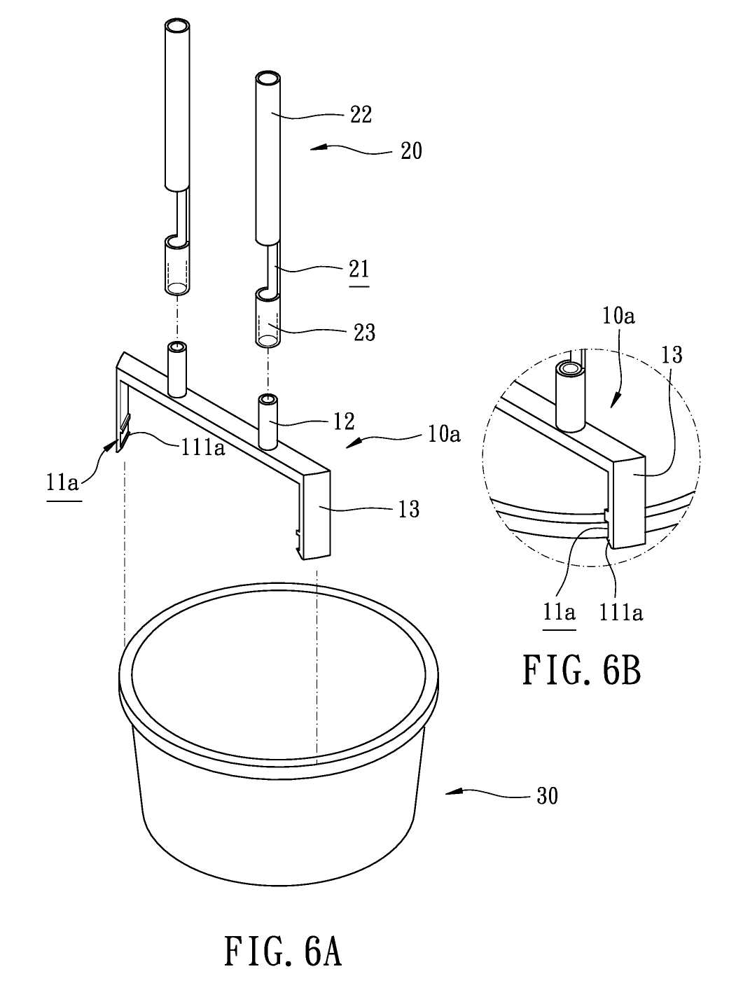

Referring to FIGS. 6A and 6B, a second embodiment of the support in accordance with the present invention is illustrated. The support comprises a base 10a and at least one tube 20 connected to the base 10a.

The base 10a has two perpendicular extensions 13 respectively downwardly extending from two distal ends thereof. Each extension 13 has a concavity 11a defined in an inner side thereof and a hook 111a inwardly extending from a distal end thereof. The concavities 11a and the hooks 111a are adapted to be connected to a top edge of a pot 30 for assembling steadily. The base 10a has at least one protrusion 12 on an opposite side relative to the two extensions 13.

The at least one tube 20 has a partial opening 21 laterally defined therein for inserting the flower stalk into the at least one tube 20. The at least one tube 20 is divided into an upper portion 22 and a lower portion 23 by the partial opening 21. The upper portion 22 is longer than the lower portion 23 for supporting the flower stalk and the lower portion 23 is axially disposed to the at least one protrusion 12 for securing the at least one tube 20.

The extensions 13 are used to keep a distance between the base 10a and the pot 30, therefore the leaves and roots of flower get more space to expand. The operation and other effects of the second embodiment of the support are the same with those of the first embodiment of the support, and therefore the detail description is omitted.

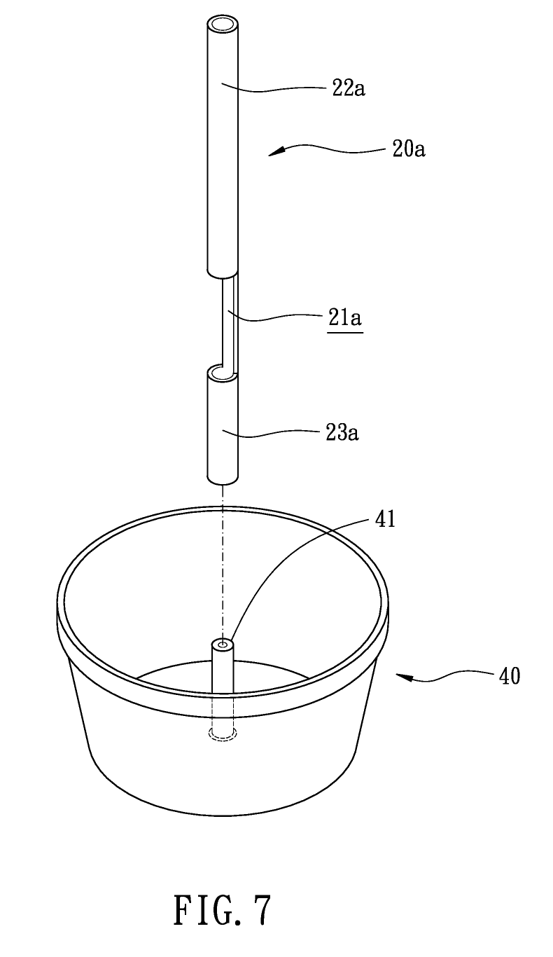

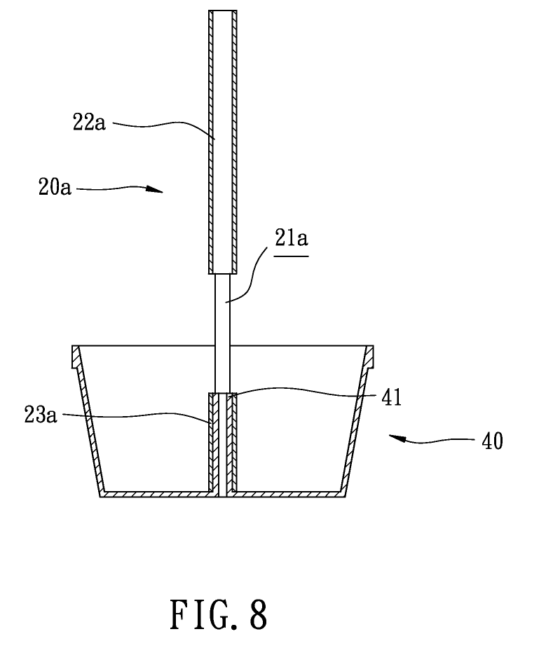

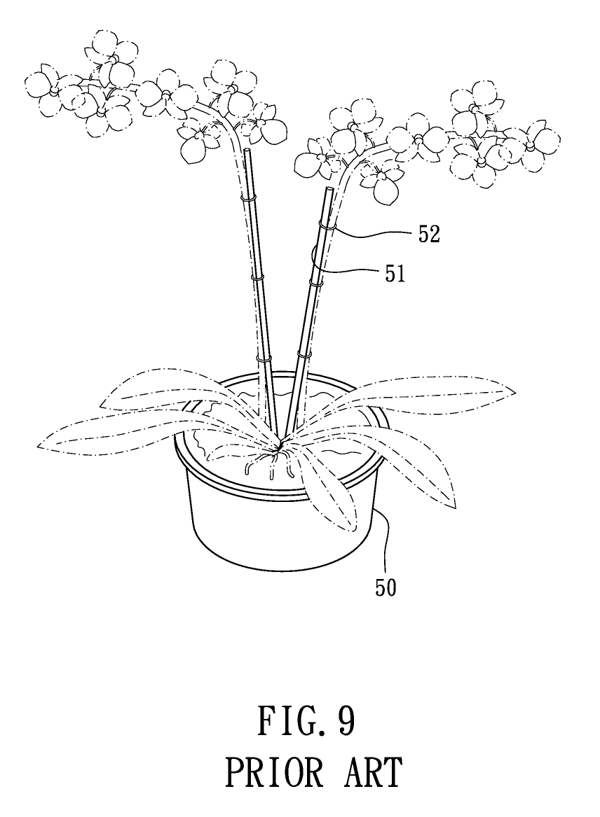

Referring to FIGS. 7 and 8, a third embodiment of the support in accordance with the present invention is illustrated. The support comprises a protrusion 41 and a tube 20a connected to the protrusion 41.

The protrusion 41 is adapted to be perpendicularly connected to a bottom of a pot 40. The protrusion 41 is disposed in a center of the pot 40.

One end of the tube 20a is axially disposed to the protrusion 41. The tube 20a has a partial opening 21a laterally defined therein for inserting the flower stalk into the tube 20a. The tube 20a is divided into an upper portion 22a and a lower portion 23a by the partial opening 21a. The upper portion 22a is longer than the lower portion 23a for supporting the flower stalk and the lower portion 23a is axially disposed to the protrusions 41 for securing the tube 20a.

The operation and effects of the third embodiment of the support are the same with those of the first embodiment of the support, and therefore the detail description is omitted.

Although the invention has been explained in relation to its preferred embodiment, it is to be understood that many other possible modifications and variations can be made without departing from the spirit and scope of the invention as hereinafter claimed.

What is claimed is:

1. A support for flower stalks comprising:
a base having at least one concavity defined in a bottom thereof and at least one protrusion upwardly extending from a top thereof, the at least one concavity adapted to be connected to a pot for assembling the support steadily; and
at least one tube longitudinally connected to the at least one protrusion, the at least one tube having a partial opening laterally defined therein for inserting the flower stalk into the at least one tube to prevent the flower stalk from being bended/broken.

2. The support for flower stalks as claimed in claim 1, wherein the at least one tube is divided into an upper portion and a lower portion by the partial opening, the upper portion being longer than the lower portion for supporting the flower stalk, the lower portion axially disposed to the at least one protrusion for securing the at least one tube.

3. The support for flower stalks as claimed in claim 1, wherein the base has at least one hook downwardly extending from a distal end thereof and adjacent to the at least one concavity for enhancing steadiness.

4. A support for flower stalks comprising:
a base having two perpendicular extensions respectively downwardly extending from two distal ends thereof, each of the extensions having a concavity defined in an inner side thereof, the concavities adapted to be connected to a pot for assembling the support steadily, the base having at least one protrusion on an opposite side relative to the extensions; and
at least one tube longitudinally connected to the base, one end of the at least one tube axially disposed to the at least one protrusion, the at least one tube having a partial opening laterally defined therein for inserting the flower stalk into the at least one tube to prevent the flower stalk from being bended/broken.

5. The support for flower stalks as claimed in claim 4, wherein the at least one tube is divided into an upper portion and a lower portion by the partial opening, the upper portion being longer than the lower portion for supporting the flower stalk, the lower portion axially disposed to the at least one protrusion for securing the at least one tube.

6. The support for flower stalks as claimed in claim 4, wherein each extension has a hook inwardly extending from a distal end thereof for enhancing steadiness.

7. A support for flower stalks comprising:
a protrusion adapted to be perpendicularly connected to a bottom of a pot; and
a tube longitudinally connected to the protrusion, one end of the tube axially disposed to the protrusion, the tube having a partial opening laterally defined therein for inserting the flower stalk into the tube to prevent the flower stalk from being bended/broken.

8. The support for flower stalks as claimed in claim 7, wherein the tube is divided into an upper portion and a lower portion by the partial opening, the upper portion being longer than the lower portion for supporting the flower stalk, the lower portion axially disposed to the protrusion for securing the tube.

9. The support for flower stalks as claimed in claim 7, wherein the protrusion is disposed in a center of the pot.
